(19) United States
(12) Patent Application Publication
(10) Pub. No.: US 2006/0238507 A1
(43) Pub. Date: Oct. 26, 2006

(54) Wireless mouse for receiving a receiver therein

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/111,896

(22) Filed: Apr. 22, 2005

(51) Int. Cl. G09G 5/08

(52) U.S. Cl. 345/163

(57) ABSTRACT

A wireless mouse for receiving a receiver is described. The wireless mouse has a mouse body, a circuit board and a receiver. The mouse body has an upper casing and a lower casing mating with each other, the circuit board is disposed on the lower casing of the mouse body, and the receiver is separably disposed on any places of an inner portion, such as the inner bottom edge or the inner top edge, of an upper casing by an inserting or a retaining method. The wireless mouse is thus convenient to carry and collect because the receiver is received in the upper casing of the mouse body. Moreover, the design of the present invention does not affect an inner structure of the wireless mouse, and is convenient for users to carry around and collect.

### BACKGROUND OF THE INVENTION

1. Field of the Invention

The present invention relates to a wireless mouse for receiving a receiver therein, and particularly relates to a receiver disposed on an inner face of an upper casing of a mouse body. Therefore, it is convenient for users to carry and collect the wireless mouse.

2. Description of the Related Art

People increasingly like to use a wireless mouse. The wireless mouse is convenient for a user, because the wireless mouse lacks a signal wire. However, a receiver is necessary for the wireless mouse to receive the movement signal of the wireless mouse.

Because of the two-part design of the wireless mouse, the wireless mouse is inconvenient to carry around. Moreover, the receiver is easily damaged or lost during carrying around or collection.

Hence it is important to provide a wireless mouse that can prevent the receiver from being damaged or lost during carrying around or collection.

### SUMMARY OF THE INVENTION

The present invention provides a wireless mouse for receiving a receiver therein in order to resolve the above problems. A receiver can be disposed on any part of an inner portion of an upper casing of the wireless mouse. The design of the present does not affect an inner structure of the wireless mouse, and is convenient for users to carry around and collect.

One aspect of the invention is a wireless mouse for receiving a receiver therein. The wireless mouse comprises a mouse body, a circuit board and a receiver. The mouse body has an upper casing and a lower casing mating with each other, the circuit board is disposed on the lower casing of the mouse body, and the receiver is separably disposed on the upper casing (such as an inner top edge or a top edge of the upper casing) of the mouse body. The wireless mouse is thus convenient to carry and collect because the receiver is received in the upper casing of the mouse body.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective, schematic view of a wireless mouse before a receiver is received therein according to the first embodiment of the present invention, with an upper casing thereof open;

FIG. 2 is a perspective, schematic view of a wireless mouse after a receiver is received therein according to the first embodiment of the present invention, with an upper casing thereof opened;

FIG. 3 is a perspective, schematic view of a wireless mouse before a receiver is received therein according to the second embodiment of the present invention, with an upper casing thereof open;

FIG. 4 is a perspective, schematic view of a wireless mouse after a receiver is received therein according to the second embodiment of the present invention, with an upper casing thereof open;

FIG. 5 is a perspective, schematic view of a wireless mouse before a receiver is received therein according to the third embodiment of the present invention, with an upper casing thereof open;

FIG. 6 is a perspective, schematic view of a wireless mouse after a receiver is received therein according to the third embodiment of the present invention, with an upper casing thereof open;

FIG. 7 is a perspective, schematic view of a wireless mouse before a receiver is received therein according to the fourth embodiment of the present invention, with an upper casing thereof open; and

FIG. 8 is a perspective, schematic view of a wireless mouse after a receiver is received therein according to the fourth embodiment of the present invention, with an upper casing thereof open.

### DETAILED DESCRIPTION OF PREFERRED EMBODIMENTS

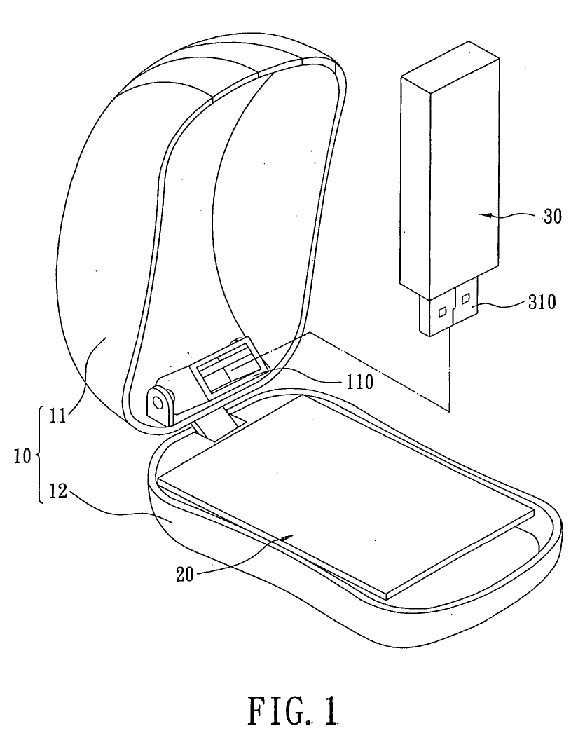

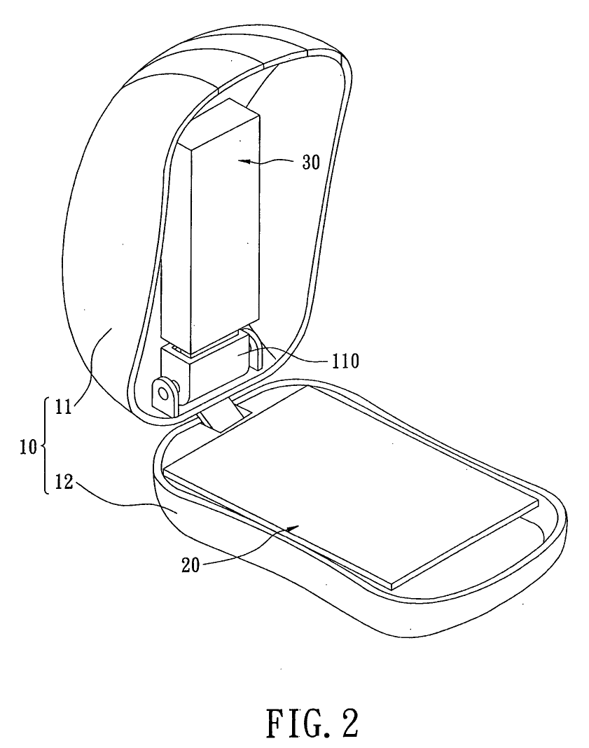

Referring to FIGS. 1 and 2 show a perspective, schematic view of a wireless mouse before and after a receiver is received therein, according to the first embodiment of the present invention, respectively. The wireless mouse comprises a mouse body 10, a circuit board 20 and a receiver 30.

The mouse body 10 has an upper casing 11 and a lower casing 12 mating with each other. The upper casing 11 and the lower casing 12 can pivotally mate with each other at any place. However, the mating method is not to be construed as a limitation upon the present invention. The circuit board 20 is disposed or fixed on the lower casing 12 of the mouse body 10.

Moreover, the upper casing 11 further comprises a receiving groove 110 pivotally disposed on an inner bottom edge thereof for receiving a receiver plug 310 of the receiver 30. Hence, the receiver 30 is separably disposed on the inner bottom edge of the upper casing 11 of the mouse body 10.

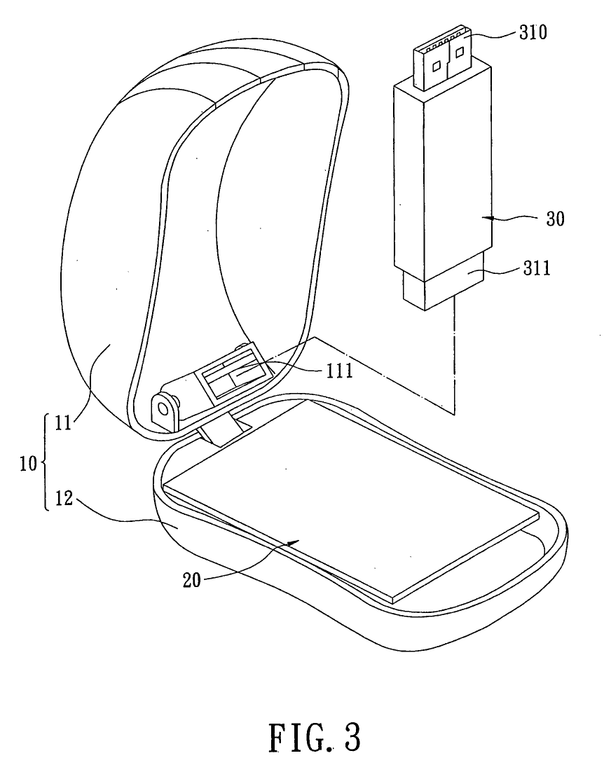

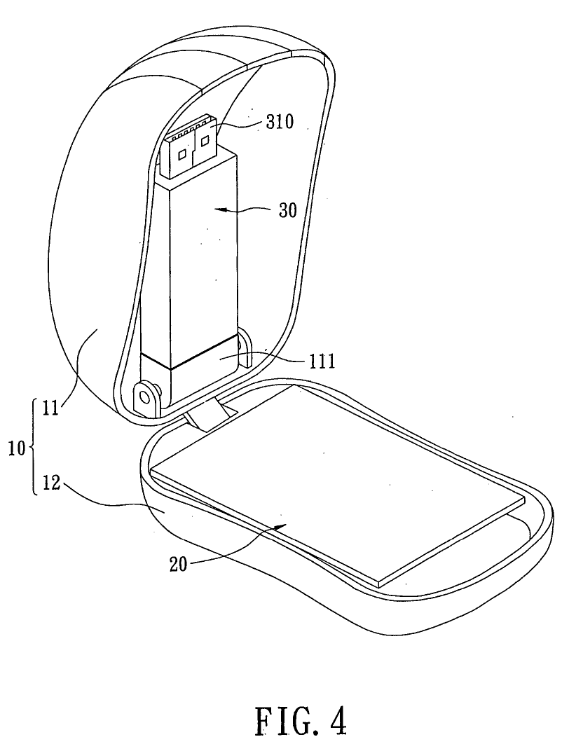

FIGS. 3 and 4 show a perspective, schematic view of a wireless mouse before and after a receiver is received therein according to the second embodiment of the present invention, respectively. The difference between the first embodiment and the second embodiment is that the upper casing 11 has a first retaining portion 111 pivotally disposed on an inner bottom edge thereof. The receiver 30 has a second retaining portion 311 disposed on a bottom side thereof and corresponding to the first retaining portion 310, and the receiver 30 is received in the second retaining portion 311 of the upper casing 11 by the first retaining portion 310. Hence, the receiver 30 is disposed on the inner bottom edge of the upper casing 1.

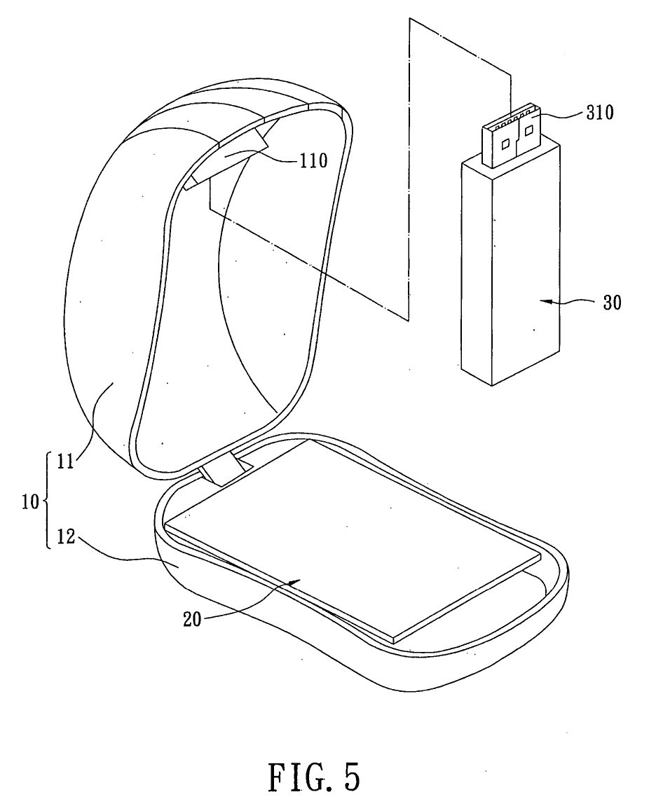

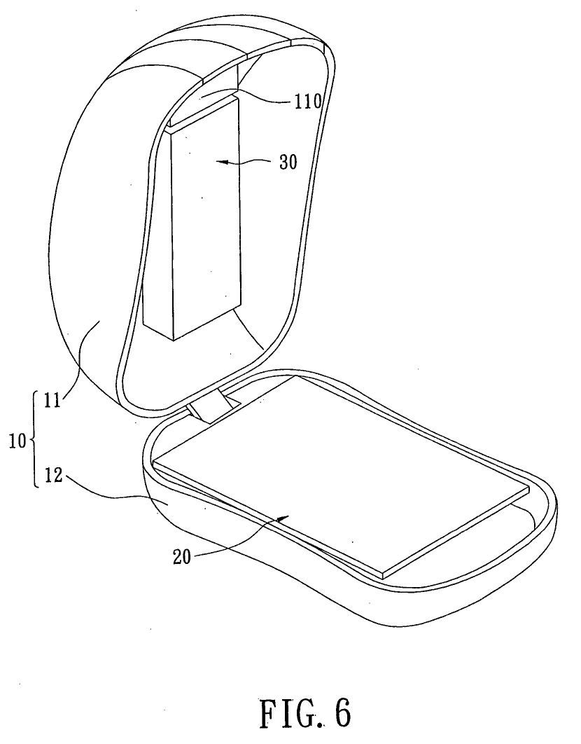

Referring to FIGS. 5 and 6 show a perspective, schematic view of a wireless mouse before and after a receiver is received therein according to the third embodiment of the present invention, respectively. The upper casing 11 has a receiving groove 110 pivotally disposed on an inner top edge thereof for receiving a receiver plug 310 of the receiver 30. Hence, the receiver 30 is separably disposed on the inner top edge of the upper casing 11 of the mouse body 10.

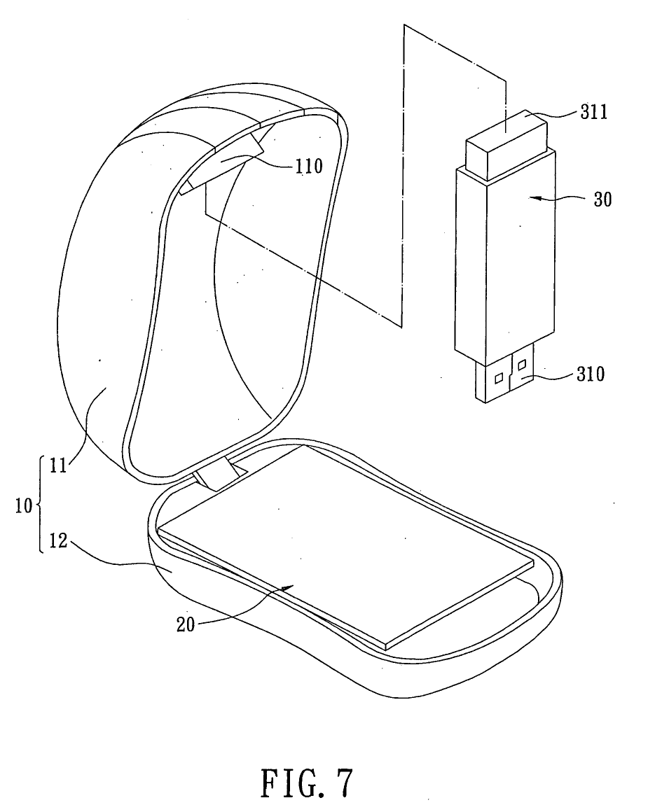

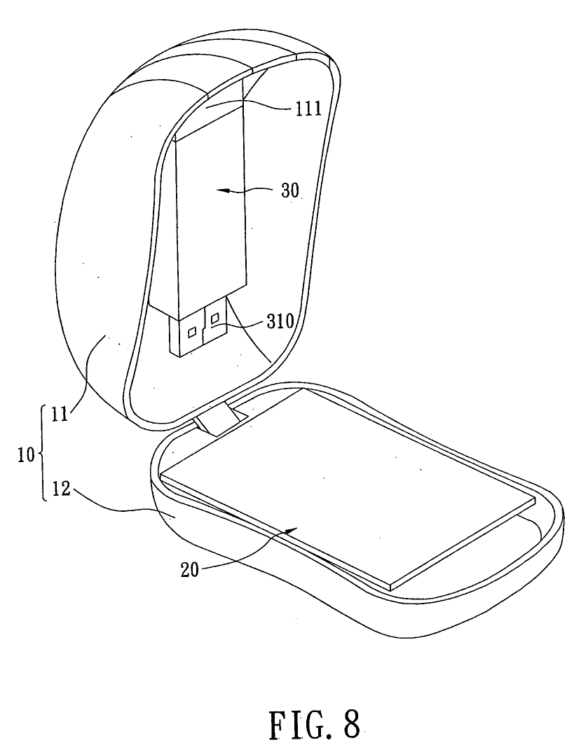

Referring to FIGS. 7 and 8 show a perspective, schematic view of a wireless mouse before and after a receiver is received therein according to the fourth embodiment of the present invention, respectively. The upper casing 11 has a first retaining portion 111 pivotally disposed on an inner top edge thereof. The receiver 30 has a second retaining portion 311 disposed on a top side thereof and corresponding to the first retaining portion 310, and the receiver 30 is received in the second retaining portion 311 of the upper casing 11 by the first retaining portion 310. Hence, the receiver 30 is disposed on the inner top edge of the upper casing 11.

In conclusion, the receiver 30 can be disposed on any part of an inner portion, such as the inner bottom edge or the inner top edge, of an upper casing by an inserting or a retaining method. The design of the present does not affect an inner structure of the wireless mouse, and is convenient for users to carry around and collect.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless mouse, comprising:
a mouse body having an upper casing and a lower casing mating with each other;
a circuit board disposed on the lower casing of the mouse body; and
a receiver separably disposed on the upper casing of the mouse body;
wherein the wireless mouse is convenient to carry and collect because the receiver is received in the upper casing of the mouse body.

2. The wireless mouse as claimed in claim 1, wherein the upper casing and the lower casing pivotally mate with each other.

3. The wireless mouse as claimed in claim 1, wherein the upper casing comprises a receiving groove for receiving a receiver plug of the receiver.

4. The wireless mouse as claimed in claim 1, wherein the upper casing comprises a first retaining portion.

5. The wireless mouse as claimed in claim 4, wherein the receiver comprises a second retaining portion disposed on a bottom side thereof and corresponding to the first retaining portion, and the receiver is received in the second retaining portion of the upper casing by the first retaining portion.

6. The wireless mouse as claimed in claim 3, wherein the receiving groove or the first retaining portion is pivotally disposed on an inner bottom edge of the upper casing.

7. The wireless mouse as claimed in claim 4, wherein the receiving groove or the first retaining portion is pivotally disposed on an inner bottom edge of the upper casing.

8. The wireless mouse as claimed in claim 3, wherein the receiving groove or the first retaining portion is pivotally disposed on an inner top edge of the upper casing.

9. The wireless mouse as claimed in claim 4, wherein the receiving groove or the first retaining portion is pivotally disposed on an inner top edge of the upper casing.

10. A wireless mouse, comprising:
a mouse body having an upper casing and a lower casing mating with each other;
a circuit board disposed on the lower casing of the mouse body; and
a receiver separably disposed on an inner bottom edge of the upper casing of the mouse body;
wherein the wireless mouse is convenient to carry and collect because the receiver is received in the upper casing of the mouse body.

11. The wireless mouse as claimed in claim 10, wherein the upper casing and the lower casing pivotally mate with each other.

12. The wireless mouse as claimed in claim 10, wherein the upper casing comprises a receiving groove for receiving a receiver plug of the receiver.

13. The wireless mouse as claimed in claim 10, wherein the upper casing comprises a first retaining portion.

14. The wireless mouse as claimed in claim 13, wherein the receiver comprises a second retaining portion disposed on a bottom side thereof and corresponding to the first retaining portion, and the receiver is received in the second retaining portion of the upper casing by the first retaining portion.

15. The wireless mouse as claimed in claim 12, wherein the receiving groove or the first retaining portion is pivotally disposed on an inner bottom edge of the upper casing.

16. The wireless mouse as claimed in claim 13, wherein the receiving groove or the first retaining portion is pivotally disposed on an inner bottom edge of the upper casing.

17. A wireless mouse, comprising:
a mouse body having an upper casing and a lower casing mating with each other;
a circuit board disposed on the lower casing of the mouse body; and
a receiver separably disposed on an inner top edge of the upper casing of the mouse body;
wherein the wireless mouse is convenient to carry and collect because the receiver is received in the upper casing of the mouse body.

18. The wireless mouse as claimed in claim 17, wherein the upper casing and the lower casing pivotally mate with each other.

19. The wireless mouse as claimed in claim 17, wherein the upper casing comprises a receiving groove for receiving a receiver plug of the receiver.

20. The wireless mouse as claimed in claim 17, wherein the upper casing comprises a first retaining portion.

21. The wireless mouse as claimed in claim 20, wherein the receiver comprises a second retaining portion disposed on a bottom side thereof and corresponding to the first retaining portion, and the receiver is received in the second retaining portion of the upper casing by the first retaining portion.

22. The wireless mouse as claimed in claim 19, wherein the receiving groove or the first retaining portion is pivotally disposed on an inner top edge of the upper casing.

23. The wireless mouse as claimed in claim 20, wherein the receiving groove or the first retaining portion is pivotally disposed on an inner top edge of the upper casing.
